(19) United States
(12) Patent Application Publication
(10) Pub. No.: US 2014/0214178 A1
(43) Pub. Date: Jul. 31, 2014

(54) CONTROL DEVICE FOR AN AUTOMATION SYSTEM

(71) Applicant: Jean-luc Bettiol, (US)

(72) Inventor: Jacques Desrousseaux, Saint Maximin la Sainte Baume (FR)

(73) Assignee: Jean-luc Bettiol, Marseille (FR)

(21) Appl. No.: 13/771,522

(22) Filed: Feb. 20, 2013

(30) Foreign Application Priority Data
Jan. 31, 2013 (FR) 13 50821

(51) Int. Cl. G05B 11/01

(52) U.S. Cl. CPC G05B 11/01
USPC 700/9

(57) ABSTRACT

This control device is provided for an automation system comprising members to be controlled (42, 43, 44) connected to said control device via various connections of the BUS type (50, 51) by the intermediary of interface circuits (55, 56, 57). This control device depends on a PC and is constituted using a command environment, operating using an interpreted language. It is formed of a development portion in order to determine the management of the various members to be controlled and an operational portion in order to act on said members to be controlled.

This invention relates to a control device for an automation system comprising members to be controlled connected to said control device by various connections of the BUS type by the intermediary of at least one interface circuit.

This type of device has substantial applications. In particular it makes it possible to define the commands and also to provide for the surveillance of automation systems that can have a complex structure.

Such a device is known in patent document EP0278802.

This known device proposes to use a plurality of command sets for members to be controlled. This device therefore has a complex structure of which the operation seems difficult to control.

This invention proposes a device of the type mentioned in the preamble which aims to avoid complications and which has facilities for the design and implementation of the automatism to which the device of the invention is assigned.

For this, such a device is remarkable in that said device depends on a PC and is constituted using a command environment, operating using an interpreted language and being formed of a development part in order to determine the management of the various members to be controlled and an operational portion in order to act on said members to be controlled.

As such, the invention proposes to centralise the control of the automation system, for its operation as well as for its development. The use of interpreted language makes it possible to easily modify the commands and establish operating phases very simply. Current PCs have good characteristics in terms of speed and the interpretation of commands does not negatively affect the rapidity of the system. Furthermore, the presence of a PC allows for the use of high-capacity memories which procures substantial facilities for the management of the automation systems that are assigned to it.

The following description accompanied with the herein annexed drawings, with the whole provided by way of a non-restricted example, will provide understanding as to how the invention can be carried out. In the drawings:

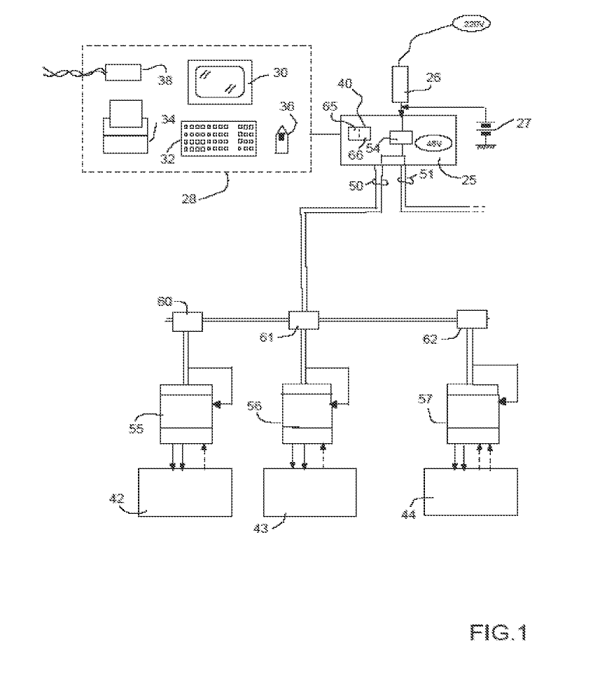

FIG. 1 shows the diagram of a device in accordance with the invention,

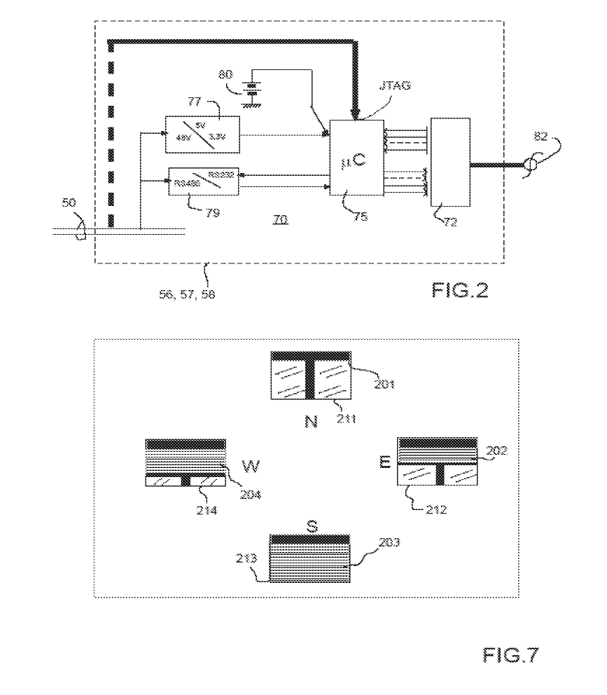

FIG. 2 shows the structure of an interface circuit adapted to receive the commands of the device of the invention,

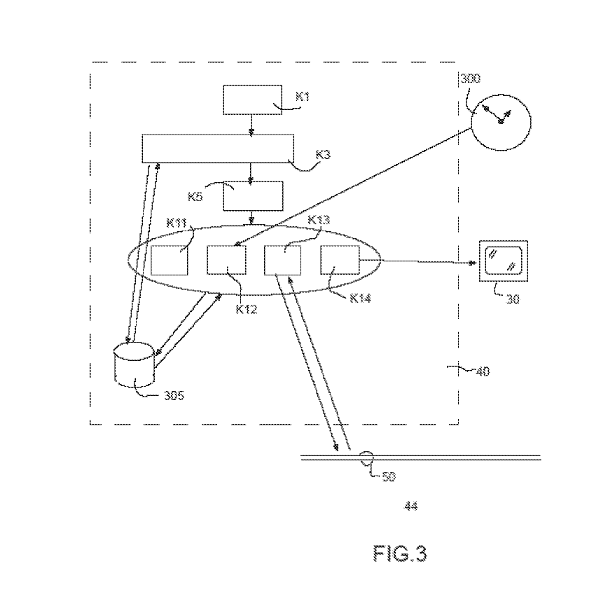

FIG. 3 shows a diagram showing the operation of the control device of the invention,

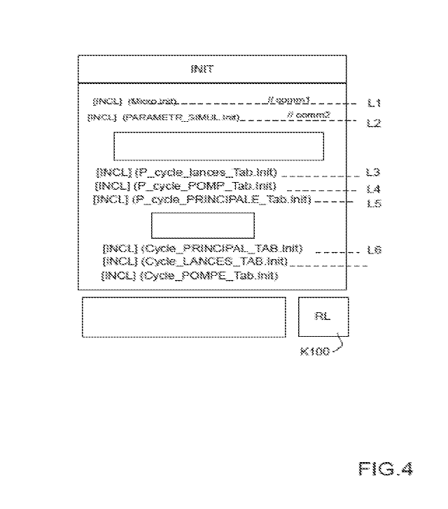

FIG. 4 shows a first screen viewed on the screen of the control device in accordance with the invention, relating to the initialisation of the operation programme of the control device of the invention,

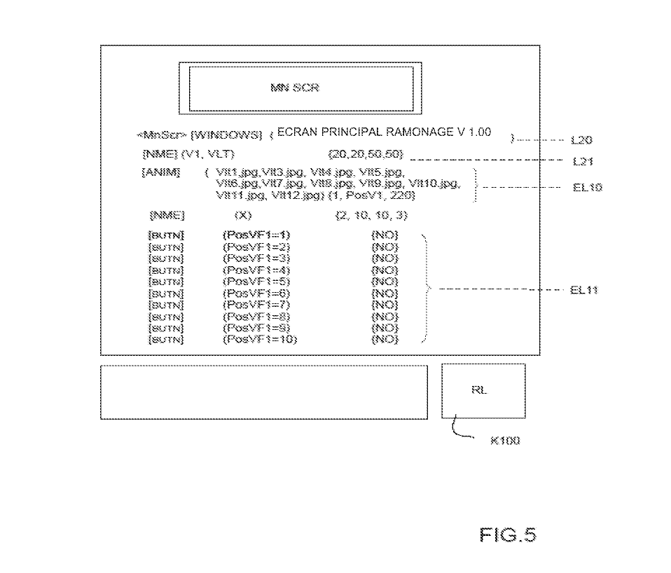

FIG. 5 shows a second screen viewed on the control device in accordance with the invention, relating to the main screen,

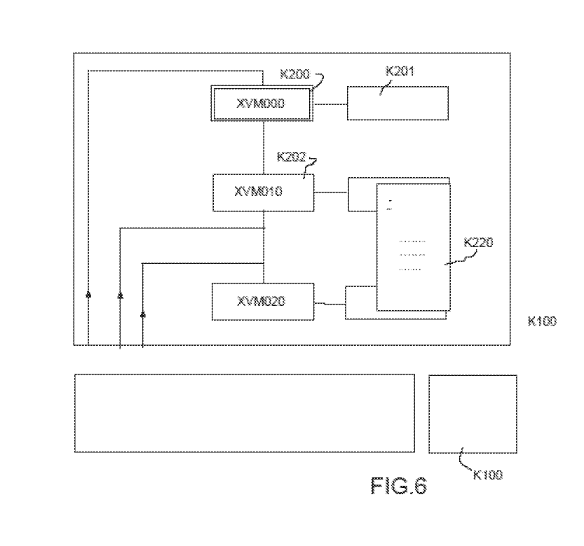

FIG. 6 shows a third screen appearing on the screen of the control device in accordance with the invention, relating to the management of graphics of the “grafcet” type or the like,

FIG. 7 shows a fourth screen appearing on the screen of the control device in accordance with the invention relating to the viewing of elements of the automation system.

In these figures, the common elements all bear the sale references.

FIG. 1 shows a device in accordance with the invention. This device substantially comprises a computer of the industrial PC type 25. This computer 25 is powered with 12 volts DC or by a main power adaptor 26 or by a battery 27 if the device is to be a part of an onboard system.

To this computer is connected a set of peripheral devices 28 constituted substantially by a screen 30, a keyboard 32, a printer 34, a mouse 36 and a modem 38 allowing for a connection via Internet. This computer 25 works in cooperation with a set of software cooperating with a programme-memory unit 40.

In order to connect the computer 25 to the various members to be controlled 42, 43 and 44 (for example: thermometers, pressure gauges, solenoid valves, different measures are proposed. Indeed, a communication must be provided between this computer 25 and these members of which the operating phases must be managed.

First of all, a first BUS line 50 and a second line 51 connected to the computer 25 have been provided for this. These lines are preferably of the RJ485 type and transmit data. The connection cable of the lines 50 and 51 also transmits power to all of the interfaces 55, 56, 57, etc. The line 50 is connected to various interface circuits 55, 56 and 57 by using junction boxes 60, 61 and 62. For reasons of clarity in the explanations, the junctions with the line 51 will not be mentioned, as the latter may be carried out in the same way.

According to a major characteristic of the invention, the programme-memory unit comprises memory areas 65 and 66 dedicated to instructions which make it possible respectively to determine the management of the members to be controlled and to act on these members during operations.

FIG. 2 shows the structure common to all of the interfaces that can be used, in particular the circuits 55, 56 and 57, by the system of the invention. These interface circuits are formed from the same basic circuit 70 to which is associated adapted circuits 72. These adapted circuits 72 permit the dialogue with the operating blocks or members. The basic circuit 70 substantially comprises a microcontroller 75 which must be programmed by a programme injected on its JTAG terminal formed in fact by 4 accesses for conducting wires, a convertor set 77 which, using the voltages carried by the line 50, provide the voltages required to power the various components of the interface circuit for example voltages of 5 VDC and 3.3 VDC, a RS485/RS232 protocol converter, of which the reference is 79, which converts the signals of the BUS 50 into signals that response to the RS232 protocol in order to be admitted by the microcontroller 75. A backup battery 80 is provided which allows for operation of the microcontroller 75, in particular by saving certain important pieces of data, the state of the memories of the microcontroller and as such offer the possibility of executing the functions that are indispensable in the event the power is cut off. The microcontroller dialogues with the computer 25 via an RS232 port. The presence of the RS485/RS232 convertor, of which the reference is 79, is justified for the following reason. Indeed, an RS232 connection does not make it possible to transmit the signal over a distance greater than 30 m at 9600 baud. The RS485 protocol tolerates distances that are much greater which provides a high degree of flexibility for the setting up of the system of the invention. The programme of the microcontroller is written to the memory of the microcontroller in the factory via the JTAG connection. Its initialisation making it possible to define the identification address as well as the functions that will have to be used is done through bus lines 50 and 51.

FIG. 3 shows the organisation of the operation of the control device. This organisation is based on the information implemented in the memory 40 of the computer 25. This organisation in particular calls upon the system. clock 300 of the computer 25 and on its mass storage memory 305. The screen 30 is also used. The other elements of the computer components can also be used.

In order to operate according to the characteristics of the invention, a complete development environment for automation and data acquisition which more particularly can he used with the automation system is used. Once the operation phases have been established, it is then possible by using the same machine to implement the application at the customer, i.e. the end user.

The operation is based on interpreting files; therefore, in order to trigger operation, the path and the name of the file containing the list of files to be interpreted (box K1) is provided as an argument.

So in a first step, it loads and analyses all of the files concerned, This is shown in box K3.

Following this analysis, all of the variables and actions are created as well as the windows of the screens and the automatisms which are determined by analysing the “grafcets” developed to define the various actions to execute with the functional blocks (see box K5), These various phases are shown in boxes K11, K12, K13 and K14 relatives respectively to the automatisms, to the variables, to the actions to initiate on members to be controlled and to the screens to be developed.

The software has a screen generator making it possible to create the user interfaces for supervision. It is possible to view the variables and create animations. Certain buttons can act directly on the interfaces making it possible to have a manual action for example in order to initialise them.

Finally, the application is started which makes it possible to have the elements created interact together and with the mass storage memory 305 in order to read or write files) and the BUS lines, the line 50 (in order to dialogue with the various interface circuits involved in the automatisms to be managed.)

Action on a button on the screen can trigger an operation which changes the value of a variable. The changing of the value of a variable can render true to the condition for starting an automatism. The automatism can trigger a dialogue with an interface circuit via the BUS line 50. This dialogue can change the value of a variable which is displayed. In the declaration of the variable, it may have been requested that it be recorded in the mass storage memory so that it takes the last known value in the event the programme is started again. This event can occur for example in the event the power is cut off. In this case, the file containing the value of the variable will be modified. The screen will also be modified and will display the new value of the variable.

All that refers to time (stoppage of an automatism for a given length of time, signal for starting an automatism, etc.) uses the internal clock 300 of the PC. This makes it possible to programme times from a millisecond up to several years without adding any additional equipment.

To use the software to create an application, it is imperative that a file describing a screen involving a file editor and a screen for debugging be included. A button making it possible to fully restart the software can be present on these screens and authorise a restart in less than ten seconds if the developer wants to know the effects of the modification of the files on the operation.

FIG. 4 shows the screen 30. This screen shows the initialisation phase. A few lines are shown as an example.

The lines L1 to L3 are relative to the parameters concerning components of the system:
L1 mentions parameter file for the microcontrollers that are a part, in particular of the interface circuits.

L2 mentions a file for defining the parameters concerning the communication carried out by the BUS lines 50.

L3 mentions a file defining other parameters for dialogue.

The lines L4 to L6 relate to variables assigned to the various members to be controlled. For example in the framework of an example concerning the cleaning of boilers of the industrial type (incineration plant, fuel or coal electricity producing plants, etc.), parameters are assigned to the hoses that inject cleaning liquid inside the boilers (line L4), to the injection pumps (line L5) and other variables (line L6).

Finally, the lines L7 to L9 relate to the initial variables of the “grafcet” diagrams which define the operation of the system.

As such the line L7 relates to the variables of the main cycle of the “grafcets”, the line L8 to the pumps, etc.

Note that, on this FIG. 4 and the following figures the presence of a box K100 which restarts the entire software implemented, when clicked. It is this box that constitutes the aforementioned restart button.

FIG. 5 shows various parameters that govern the appearance of the main screen that the user sees.

The line L20 relates to the name that is assigned to this screen. The line L21 defines a frame for a VLT object.

The set of lines EL10 relates to a set of indexed images (Vlt1 to Vlt12), according to the value of the index which varies between 1 and 12, an image will be selected.

The set of lines EL11 relates to various buttons which can be made to appear and which can, when they are selected, carry out various tasks.

FIG. 6 shows a “grafcet” diagram established to define the operation of the automation system. This “grafcet” can be modified by the editor of the software incorporated into said control device. This diagram causes a double box K200 to appear which is the starting box so that the operation unfolds the task contained in the box K202 must allow for this and control moves to the box K203 and so forth in accordance with the procedure of the “grafcet” files. It is possible to easily modify the “grafcet” diagram. It is this diagram that defines a chained operation of the various operating steps. Via a right click of the mouse 36 it is possible to display a contextual menu (box K220) in order to facilitate the modification or the design of this “grafcet” diagram.

FIG. 7 diagrammatically shows a view of the position of the shutters 201, 202, 203, 204 attached to windows 211, 212, 213, 214 still within the framework of an example. The automatism has for purpose to determine the lowering of these shutters in order to manage for example the temperature of the rooms that it is supposed to control. FIG. 7 shows the shutters arranged to the North (N) to the South (S) to the East (E) and to the West (W). The lowering of these shutters is measured by the positioning of a sensor located at their level and the value of this positioning is transmitted to the control device which finally determines the value of the index of the different images illustrating this lowering representing as best as possible the actual lowering. This constitutes an approach of the supervision of the system to be controlled. It is also possible to display various values measured on the system in order to verify the proper operation of the system.

All of the operations indicated are carried out by a programming language operating according to the interpreted mode that is proper to the software making it possible to manage several languages.

The supervision can consist in opening a window comprising an index indicating the step in progress. In order to determiner an anomaly, stoppage points can be assigned to these steps and control the value of critical variables. The supervision will indicate the values and also the designation of this variable.

1. Control device for an automation system comprising members to be controlled (42, 43, 44) connected to said control device by various connections of the BUS type (50, 51) by the intermediary of at least one interface circuit (55, 56, 57), characterised in that said control device depends on a PC and is constituted using a command environment, operating using at least one interpreted language and being formed of a development portion in order to determine the management of the various members to be controlled and of an operational portion in order to act on said members to be controlled (42, 43, 44).

2. Control device for an automation system according to claim 1 characterised in that said environment is common to at least two automation systems connected to said PC by at least two common lines (50, 51).

3. Control device for an automation system according to claim 1 wherein said interface circuits (55, 56, 57) are formed of at least one microprocessor/microcontroller (75) of which the operation depends on programme lines and/or variables inserted into a writable memory characterised in that said programme lines are managed using commands issued from said PC and transmitted via the BUS lines (50, 51).

4. Control device for an automation system according to claim 1 characterised in that a supervision portion is provided in order to provide to said PC values showing the operation of said members of said automation systems.

5. Control device for an automation system according to claim 4 characterised in that all of the supervision graphically shows on the screen the state of operation of the members to be controlled (position of the shutters).

6. Control device for an automation system according to claim 1 characterised in that a control button (K100) is provided to restart the software.

7. Control device for an automation system according to claim 1 characterised in that the interpreted language is a language specially designed for the software.

8. Control device for an automation system according to claim 1 characterised in that the environment comprises a grafcet interpreter making it possible to carry out the automatisms and to carry out the control of the interfaces.

9. Control device for an automation system according to claim 1 characterised in that the operation is based on chained operation steps which are executed sequentially determined by the waiting for a continuation value of the sequence.
